(19) United States
(12) Patent Application Publication
(10) Pub. No.: US 2026/0328036 A1
(43) Pub. Date: Oct. 22, 2026

(54) REBOUNDER FOR DAMPING DOOR AND POCKET DOOR

(71) Applicant: Guangdong OPK Smart Home Technology Co., Ltd., Zhongshan (CN)

(72) Inventor: Jiangde Xu, Zhongshan (CN)

(21) Appl. No.: 19/700,550

(22) Filed: Jun. 8, 2026

Related U.S. Application Data
(63) Continuation of application No. PCT/CN2023/138283, filed on Dec. 13, 2023.

(30) Foreign Application Priority Data
Dec. 7, 2023 (CN) 202311676461.6

(51) Int. Cl. E05F 5/00; E05F 1/16; E06B 3/46

(52) U.S. Cl. CPC E05F 5/003; E05F 1/16; E06B 3/4654; E05Y 2201/684; E05Y 2900/14

(57) ABSTRACT

Disclosed in the present invention are a rebounder for a damping door and a pocket door, including: a rebounder housing, a sliding rail being provided in the rebounder housing; a sliding member, slidably connected in the sliding rail; an elastic member, connected between the rebounder housing and the sliding member; a resisting block, assembled in the sliding rail; and a clutch structure, connected between the rebounder housing and the sliding member. The sliding member is provided with a first contact part and a second contact part having a retracting function. A spacing between the first contact part and the second contact part is a sliding space, the second contact part is located on a side close to the resisting block, and the first contact part is located on a side close to the clutch structure.

### CROSS REFERENCE TO RELATED APPLICATIONS

The present application is a Continuation Application of PCT Application No. PCT/CN2023/138283 filed on Dec. 13, 2023, which claims the benefit of Chinese Patent Application No. 202311676461.6 filed on Dec. 7, 2023. All the above are hereby incorporated by reference in their entirety.

### TECHNICAL FIELD

The present invention relates to the technical field of rebound devices, and in particular, to a rebounder for a damping door and a pocket door.

### BACKGROUND

A pocket door, as the name suggests, is to hide a door panel into a “pocket”, acting the effect of visual openness in a limited space. Generally, the pocket door is hidden in the thickness of the wall so as to avoid occupying external space, and the inside of the wall is generally provided with a rebounder abutted against the door to facilitate door ejection.

A rebounder disclosed in the existing patent CN113958242A is generally equipped with locking and popping out functions, which can realize the effect of the pocket door being locked within the wall or popped out from the inside of the wall. The existing pocket door is generally provided with a damper, which can decelerate the pocket door, and keep pushing and decelerating the pocket door until the pocket door is completely hidden and closed. When the damper and the rebounder both exist, in order to prevent the damper from interfering with the rebounder, it is usually necessary to realize a locking effect with the rebounder before the damper is activated, which requires an increase in the depth of a wall groove. Otherwise, it may result in that the locked pocket door is not able to be completely hidden into the wall, thereby causing trouble.

### SUMMARY

In order to overcome at least one of the defects described above in the prior art, provided in the present invention is a rebounder for a damping door and a pocket door. It can solve the problem of linkage cooperation between a damper and the rebounder without increasing the depth of a wall groove, which ensures that the pocket door body can be completely hidden after locked with the rebounder.

The technical solutions adopted by the present invention to solve its problems are as follows:

A rebounder for a damping door, applied to a pocket door body having a damper. The rebounder for the damping door includes: a rebounder housing, a sliding rail being provided in the rebounder housing; a sliding member, slidably connected in the sliding rail; an elastic member, connected between the rebounder housing and the sliding member; a resisting block, assembled in the sliding rail for limiting an initial sliding position of the sliding member; and a clutch structure, connected between the rebounder housing and the sliding member for adjusting a relative position of the sliding member in the sliding rail. The sliding member is provided with a first contact part and a second contact part having a retracting function. A spacing between the first contact part and the second contact part is a sliding space, the second contact part is located on a side close to the resisting block, and the first contact part is located on a side close to the clutch structure. When the second contact part is toggled to move the sliding member to an end position, the sliding member is snap-fitted with the clutch structure, the second contact part is switched to a retracted state, and the sliding space is open.

By adopting the above solution, when the pocket door body is hidden and closed, the toggle block drives the second contact part to move and causes the sliding member to be snap-fitted with the clutch structure. At this time, the sliding member slides to the end position and the second contact part is switched to the retracted state, the toggle block continues to decelerate and slide along the sliding space until the toggle block is abutted against the first contact part, so that the pocket door body still has a space for sliding towards the first contact part after the pocket door body is locked with the rebounder in the process of the pocket door body sliding and being hidden into the wall, which ensures that the decelerated sliding of the damper is not affected when the door body is closed, and at the same time, is able to completely hide the pocket door body without increasing the wall groove.

Further, a first assembly member is provided at an end of the rebounder housing, a second assembly member is provided at an opposite end of the rebounder housing, and the first assembly member and the second assembly member are configured to assemble the rebounder housing in a pocket door rail or on the pocket door body.

By adopting the above solution, the two ends of the rebounder housing can be fixed, which improves the assembly stability of the rebounder housing.

Further, the second contact part includes: a snap rotating block, rotatably connected to the sliding member; and a torsion spring, rotating the snap rotating block so that the snap rotating block protrudes from a side of the sliding member for being abutted against the pocket door body or the pocket door rail.

By adopting the above solution, the pocket door body is first abutted against the second contact part when hidden. The pocket door body is pushed to realize the locking with the rebounder, when the pocket door body is subjected to decelerated sliding of the damper, the door body can continue to be driven to move forward, and at this time, the pocket door body can compress the torsion spring to rotate the snap rotating block to the inside of the rebounder housing. When the pocket door body is abutted against the first contact part, the damper on the pocket door body completes the deceleration action, and at this time, the pocket door body is completely hidden into the wall.

Further, the snap rotating block includes: a rotating shaft part rotatably connected to the sliding member; a first snap edge, configured to be abutted against the pocket door body or the pocket door rail; and a second snap edge. The second snap edge is abutted against the torsion spring to push the second snap edge to rotate towards the first snap edge, such that the first snap edge is rotated to the outside of the sliding member with the rotating shaft part as a center.

By adopting the above solution, the torsion spring ensures that the pocket door body is abutted against the first snap edge of the snap rotating block, thereby improving the abutting force of the snap rotating block itself.

Further, a protective sliding block is slidably provided on the sliding member, a sliding direction of the protective sliding block is as same as a sliding direction of the sliding member, and the protective sliding block is located on a back side of the snap rotating block protruding from the sliding member, so that the second snap edge is abutted against the protective sliding block when the snap rotating block is rotated to protrude from the sliding member.

By adopting the above solution, it is capable of assisting the torsion spring to provide a force to the snap rotating block that causes the snap rotating block to rotate to protrude from a side of the sliding member, thereby improving the abutting force of the snap rotating block, and ensuring that the pocket door body can drive the sliding member to slide through the snap rotating block.

Further, a guiding surface is provided on a side of the protective sliding block abutted against the snap rotating block, and the guiding surface is configured to allow the snap rotating block to push the protective sliding block to slide towards the resisting block along the guiding surface when the snap rotating block is rotated into the sliding member.

By adopting the above solution, it is possible to enable the snap rotating block to act on the sliding member through the guiding surface when the snap rotating block is subjected to a relatively great force, so as to protect the rotating and retraction of the snap rotating block, and to protect its own elastic retraction effect.

Further, the clutch structure includes movable rod, an end of the movable rod being connected to the sliding member and another end thereof being bent to form a locking rod; and a snap member, the snap member being assembled in the sliding rail at an opposite end of the sliding rail, and having a snap position. The locking rod is allowed to be locked with or detached from the snap position when the sliding member drives the movable rod to move towards the snap member.

By adopting the above solution, the effect of locking and popping out of the sliding block can be realized.

The snap member includes: a snap seat body, having an accommodating cavity; and a snap limiting member, assembled in the accommodating cavity. The snap limiting member includes: a snap base plate, snap-fitted into the accommodating cavity of the snap seat body; a first limiting member, provided on the snap base plate to limit a movement direction of the locking rod when sliding; and a second limiting member. The second limiting member is provided on the snap base plate and is provided opposite to the first limiting member for cooperating with the first limiting member to allow the locking rod to slide into the snap position or slide out of the snap position.

By adopting the above solution, the guidance can be provided for the sliding of the locking rod, and realizing the effect of the locking and sliding out.

Further, the snap seat body is provided with a lateral mounting hole, the lateral mounting hole is assembled with a lateral mounting plate, and the lateral mounting hole is in communication with the accommodating cavity for mounting the snap limiting member from the lateral mounting hole.

By adopting the above solution, it facilitates to assembling the snap limiting member from the side surface of the snap seat body, thereby improving the operating space.

A pocket door includes a pocket door body, a pocket door rail and a rebounder with damping door. The rebounder housing is assembled to an upper or lower edge of the pocket door body, and a toggle block, configured to be abutted against a first contact part or a second contact part protruding from the rebounder housing, is provided in the pocket door rail; or, the rebounder housing is assembled in the pocket door rail, and a toggle block, configured to be abutted against the first contact part or the second contact part protruding from the rebounder housing, is provided on a side wall of the pocket door body, so as to enable the pocket door body to be completely hidden into a wall without being affected by the damper.

By adopting the above solution, it is possible to retain the damping effect of the damper without interfering with the function of the rebounder, while it is possible to hide the pocket door body completely.

In summary, the rebounder for a damping door and the pocket door provided in the present invention have the following technical effects: the rebounder housing has a first contact part and a second contact part spaced apart, the sliding member can be driven to realize a snap-fit effect with the clutch structure when the second contact part is abutted against the toggle block, and the toggle block can continue to decelerate and slide along the sliding space, which can allow the second contact part with retraction function to retract, thereby driving the pocket door body to be hidden into the wall. At this point, the toggle block is abutted against the first contact part, and then it can be realized that the rebounder and the damper can act individually, which avoids the mutual interference between those two. In addition, a length of the rebounder housing is relatively great, so that the space between the first contact part and the second contact part is capable of providing the sliding space for the deceleration of the door body for the damper without increasing the depth of the door body groove.

### BRIEF DESCRIPTION OF THE DRAWINGS

FIG. 1 is a schematic diagram of a three-dimensional structure of a rebounder according to an embodiment of the present invention in an initial state;

FIG. 2 is a schematic diagram of the three-dimensional structure of the rebounder of according to the embodiment of the present invention in a locking state;

FIG. 3 is a schematic structural diagram illustrating an exploded view of a gas control system according to the embodiment of the present invention;

FIG. 4 is an enlarged view at area A in FIG. 3;

FIG. 5 is an enlarged view at area B in FIG. 3;

FIG. 6 is an enlarged view at area C in FIG. 3;

FIG. 7 is a schematic diagram of a snap limiting member according to the embodiment of the present invention;

FIG. 8 is a schematic diagram illustrating a change in motion states of the rebounder according to the embodiment of the present invention; and

FIG. 9 is a schematic diagram illustrating sliding states of the pocket door body according to the embodiment of the present invention.

The meanings of the reference numerals are as follows: 1 rebounder housing; 11 sliding rail; 12 telescoping space; 13 sliding space; 14 first assembly member; 15 second assembly member; 2 elastic member; 3 resisting block; 4 movable rod; 41 locking rod; 5 snap member; 51 snap seat body; 511 accommodating cavity; 512 lateral mounting hole; 52 snap limiting member; 521 snap base plate; 5211 snap strip; 522 first limiting member; 5221 stopping rim; 5222 first guiding bump; 523 second limiting member; 5231 sloping plate; 5232 second guiding block; 5233 snap position; 53 lateral mounting plate; 6 sliding member; 61 first contact part; 62 second contact part; 621 snap rotating block; 6211 rotating shaft part; 6212 first snap edge; 6213 second snap edge; 622 torsion spring; 63 rotating hole; 64 protective sliding block; 641 guiding surface; 65 flexible member; 7 pocket door body; 8 toggle block.

### DETAILED DESCRIPTION

For a better understanding and implementation, the technical solutions in the embodiments of the present invention are clearly and completely described and discussed below in conjunction with the attached drawings of the present invention. Obviously, the embodiments described herein are only some of the embodiments of the present invention but not all of them. Based on the embodiments in the present invention, all other embodiments acquired by those skilled in the art without inventive effort fall within the scope of protection of the present invention.

In order to facilitate the understanding of the embodiments of the present invention, specific embodiments in conjunction with the attached drawings are further explained hereinafter, and each embodiment does not constitute a limitation to the embodiments of the present invention.

In the description of the present invention, it is to be noted that the terms “up”, “down”, “front”, “back”, “left”, “right”, “vertical”, “horizontal”, “top”, “bottom”, “inside”, “outside” and other orientation or position relationships are based on the orientation or position relationships shown in the attached drawings. It is only intended to facilitate description of the present invention and simplify description, but not to indicate or imply that the referred device or element has a specific orientation, or is constructed and operated in a specific orientation. Therefore, they should not be construed as a limitation of the present invention.

Unless otherwise defined, all terms including technical and scientific terms used herein have the same meaning as commonly understood by those skilled in the art to which the present invention belongs. The terms used herein in the specification of the present invention are used only to describe specific embodiments and are not intended as a limitation of the invention.

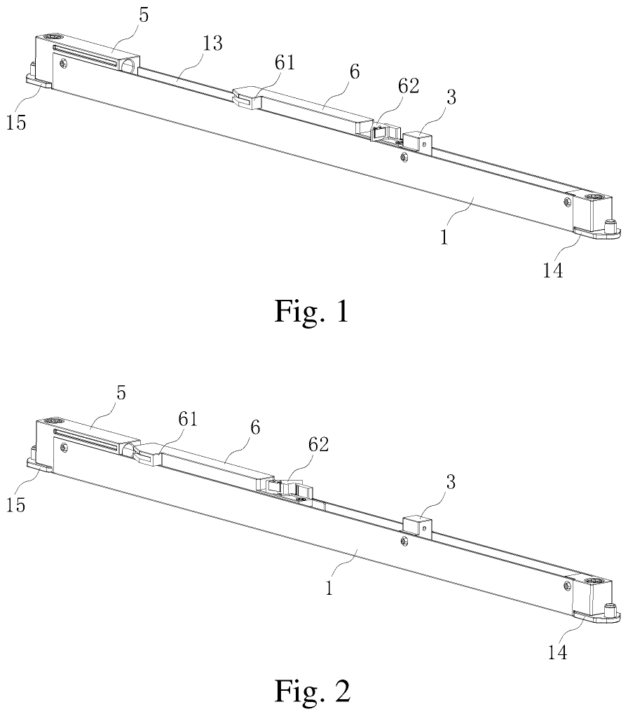

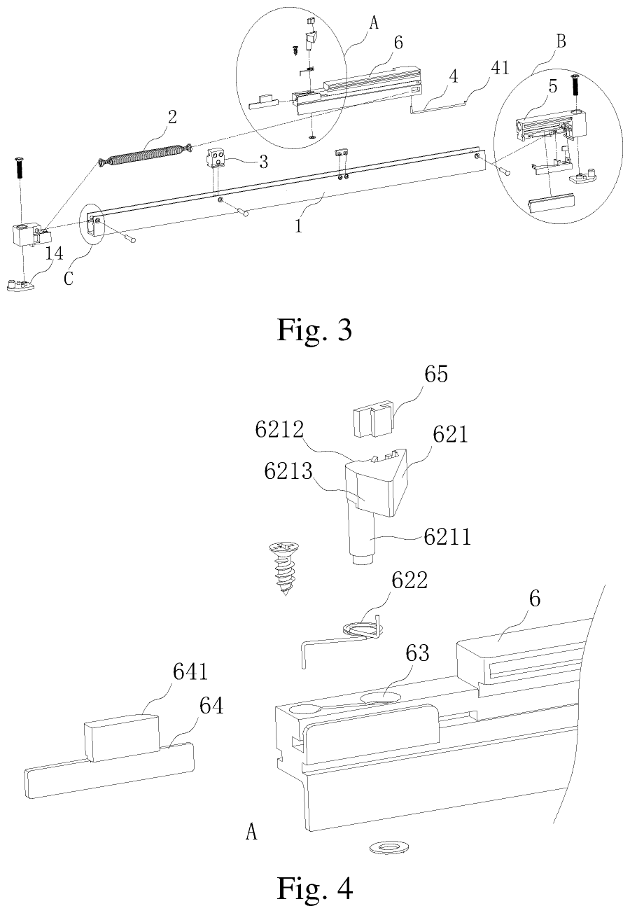

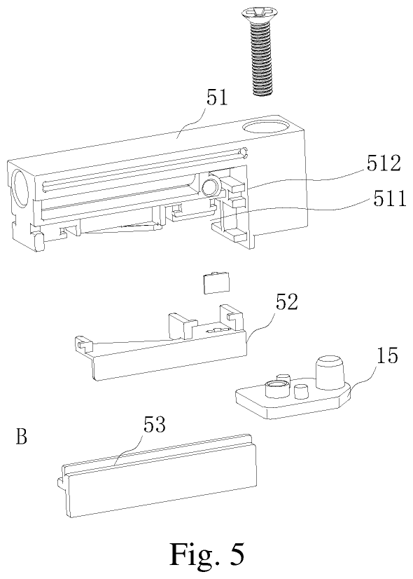

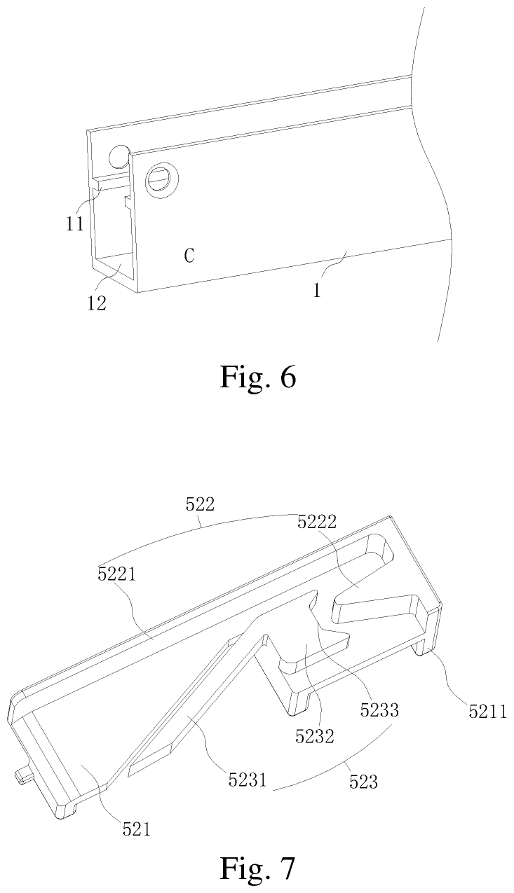

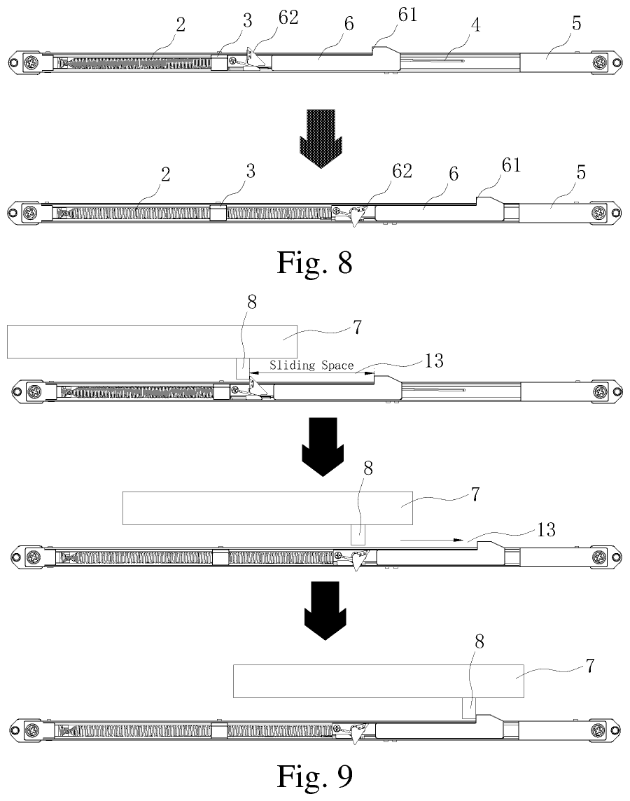

Referring to FIGS. 1 to 9, disclosed in the present invention is a rebounder for a damping door, which is applied to a pocket door body 7 having a damper, including a rebounder housing 1, and an elastic member 2, a sliding member 6, a resisting block 3 and a clutch structure all assembled in the rebounder housing 1. The rebounder housing 1 is a strip groove with openings at two ends. A sliding rail 11 is provided in the groove in a length direction. The sliding rail 11 is located at a position above a center of the groove in a depth direction of the groove, so that the groove below the sliding rail 11 has a telescoping space 12 for accommodating the elastic member 2. A first assembly member 14 is snap-fitted at an end of the rebounder housing 1. The first assembly member 14 slides and is snap-fitted from an end part of the rebounder housing 1 into the rail, and then is locked and fixed by a bolt. The first assembly member 14 has a snap position connected with an end of the elastic member 2 to realize a connection with the end of the elastic member 2. The resisting block 3 and the sliding member 6 sequentially slides into the rebounder housing 1 from an opposite end of the rebounder housing 1. The resisting block 3, after sliding to a position of a screw hole, is fixed to the rebounder housing 1 by a bolt. A space for the elastic member 2 is reserved in the strip groove below the resisting block 3, another end of the elastic member 2 passes through the space below the resisting block 3 and is connected with the sliding member 6, so that the sliding member 6 is abutted against the resisting block 3 under the rebound force of the elastic member 2 in the initial position. Finally, the clutch structure slides into the rebounder housing 1 from the opposite end of the rebounder housing 1, the clutch structure is configured to be fixed to rebounder housing 1 by a bolt when the clutch structure is located in the sliding rail 11, and finally, a second assembly member 15 is assembled on the clutch structure. The first assembly member 14 and second assembly member 15 are configured to assemble the rebounder housing 1 in a pocket door rail or on the pocket door body 7.

In order to enable the sliding member 6 to be driven to slide when the pocket door body 7 is hidden, it is necessary to provide a toggle block 8 capable of driving the sliding member 6 to move. When the first assembly member 14 and second assembly member 15 are fixed to the upper or lower edge of the pocket door body 7, the toggle block 8 is provided in the pocket door rail, and the toggle block 8 is capable of driving the sliding member 6 to slide when the pocket door body 7 is opened. When the first assembly member 14 and second assembly member 15 are assembled with the pocket door rail, the toggle block 8 is provided on one side of the pocket door body 7, is capable of driving the sliding member 6 to slide when the pocket door body 7 is hidden and closed, and achieves the locking and rebounding effect of the rebounder. By means of the first assembly member 14 and the second assembly member 15, the two ends of the rebounder housing 1 can be fixed, which improves the assembly stability of the rebounder housing 1.

In this embodiment, the first assembly member 14 and second assembly member 15 are assembled with the pocket door rail, the sliding member 6 is provided with a first contact part 61 and a second contact part 62. The second contact part 62 is configured to be abutted against the toggle block 8 of the pocket door body 7 when the pocket door body 7 is hidden and closed, which allows the sliding member 6 to be driven to slide through the second contact part 62, so as to realize the locking effect of the rebounder, and the second contact part 62 is therefore configured to play a locking role. A sliding space 13 for the sliding of the pocket door body 7 is reserved between the second contact part 62 and the first contact part 61. Specifically, the second contact part 62 includes a snap rotating block 621 and a torsion spring 622. The snap rotating block 621 includes a rotating shaft part 6211, a first snap edge 6212 and a second snap edge 6213. The sliding member 6 is provided with a rotating hole 63 accommodating the rotating shaft part 6211 and a screw position configured to fix an end of the torsion spring 622, and another end of the torsion spring 622 is abutted against the second snap edge 6213. The rotating shaft part 6211 passes through the torsion spring 622 and is inserted into the rotating hole 63, a spacer is provided between the rotating shaft part 6211 and the rotating hole 63, and then the end of the torsion spring 622 is fixed to the screw position by a screw. At this point, the torsion spring 622 rotates the snap rotating block 621 to the snap rotating block 621 to protrude from a side of the sliding member 6 for enabling the first snap edge 6212 to be abutted against the toggle block 8 of the pocket door body 7, so that the pocket door body 7 is first abutted against the second contact part 62 when hidden. When the pocket door body 7 drives the sliding member 6 to move towards the snap member 5 through the second contact part 62, a rotating force on the snap rotating block 621 is less than a twisting force of the torsion spring 622. When the pocket door body 7 moves to a position where the pocket door body 7 is in a locking state with the clutching device, the pocket door body 7 keeps moving. At this point, the sliding member 6 arrives at an end position and is unable to continue to move forward, so that the force applied on the snap rotating block 621 by the door body is greater than the twisting force of the torsion spring 622. At this point, the snap rotating block 621 compresses the torsion spring 622 to rotate into the rebounder housing 1, the second contact part 62 is switched to a retracted state, the sliding space 13 is open, the toggle block 8 is no longer in contact with the second contact part 62, and the toggle block 8 slides along the sliding space 13. During the sliding of the toggle block 8 along the sliding space 13, the damper of the pocket door body 7 begins to act to decelerate the door body until the toggle block 8 is abutted against the first contact part 61. At this point, the damper completes the deceleration of the pocket door body 7, and the pocket door body 7 is completely hidden within the wall, thereby realizing that the locking process of the rebounder of the door body is staggered from the deceleration process of the damper of the door body, so as to avoid the situation of mutual interference due to simultaneous actions of those two.

In some embodiments, in order to make an abutting force for the second contact part 62 greater, a protective sliding block 64 is slidably provided on the sliding member 6. A sliding direction of the protective sliding block 64 is as same as a sliding direction of the sliding member 6. The protective sliding block 64 is located on a back side of the snap rotating block 621 protruding from the sliding member 6, i.e., the second snap edge 6213 of the snap rotating block 621 is abutted against the protective sliding block 64. At this point, the snap rotating block 621 is rotated to protrude from the sliding member 6, and the first snap edge 6212 is capable of providing a greater force to resist with the door body when the door body is hidden, and assisting the torsion spring 622 in providing a force to the snap rotating block 621 that causes the snap rotating block 621 to rotate to protrude from a side of the sliding member 6, thereby improving the abutting force of the snap rotating block 621, so as to ensure the motion stability of the sliding member 6 driven by the pocket door body 7.

In some embodiments, in order to avoid that the snap rotating block 621 cannot be smoothly retracted when the sliding member 6 is unable to continue to move forward, a guiding surface 641 is provided on a side of the snap rotating block 621 against which the protective sliding block 64 is abutted. The guiding surface 641 is configured to allow the snap rotating block 621 to push the protective sliding block 64 to slide towards the resisting block 3 along the guiding surface 641 when the snap rotating block 621 is rotated into the sliding member 6, so that the relatively great abutting force on the snap rotation block 621 can be resolved and act on the sliding member 6 through the guiding surface 641, thus maintaining a good elastic retraction of the snap rotating block 621 itself.

In some embodiments, in order to prevent a large rigid collision between the first snap edge 6212 of the snap rotating block 621 and the toggle block 8 of the pocket door body 7, a flexible member 65 may be provided on the first snap edge 6212, thereby providing an impact buffering effect.

In this embodiment, the clutch structure includes a movable rod 4 and a snap member 5, an end of the movable rod 4 is connected to the sliding member 6, and another end is bent to form a locking rod 41. The snap member 5 is assembled at the opposite end within the sliding rail 11, and the snap member 5 has a snap position 5233. The snap member 5 includes a snap seat body 51 and a snap limiting member 52, the snap seat body 51 has an accommodating cavity 511, and the snap limiting member 52 is assembled within the accommodating cavity 511. The snap seat body 51 is provided with a lateral mounting hole 512. The lateral mounting hole 512 is assembled with a lateral mounting plate 53. The lateral mounting plate 53 is in snap-fit connection or in bolt-locked connection with the snap seat body 51. The lateral mounting hole 512 is in communication with the accommodating cavity 511 for mounting the snap limiting member 52 from the lateral mounting hole 512, thereby facilitating to assembling the snap limiting member 52 from the side surface of the snap seat body 51, and improving the operating space. The snap limiting member 52 includes a snap base plate 521, a first limiting member 522 and a second limiting member 523, the snap base plate 521 is provided with at least one snap strips 5211 which are configured to enable the snap base plate 521 to be snap-fitted into the accommodating cavity 511 of the snap seat body 51. The first limiting member 522 and the second limiting member 523 are provided on the snap base plate 521 to limit a direction of motion of the locking rod 41 when the locking rod 41 slides. The connection between the first limiting member 522 and the snap base plate 521 and the connection type between the second limiting member 523 and the snap base plate 521 include, but are not limited to, a one-piece connection or a bolt-locked connection. Specifically, the first limiting member 522 includes a stopping rim 5221 and a first guiding bump 5222 that are integrally molded, the second limiting member 523 includes a sloping plate 5231 and a second guiding block 5232, the snap position 5233 is a snap slot of the second guiding block 5232 recessed towards the second guiding block 5232 itself. The snap position 5233 is provided opposite to the second limiting member 523, i.e., the first guiding bump 5222 is provided towards the snap slot. The stopping rim 5221 is located on the side of the snap base plate 521 towards the lateral mounting hole 512. A side wall of the accommodating cavity 511 away from the lateral mounting hole 512 is set as an attaching wall, the sloping plate 5231 is located at the end of the snap base plate 521 towards the movable rod 4, the sloping plate 5231 is bent towards the attaching wall, and a gap capable of allowing the locking rod 41 to pass through is provided between the sloping plate 5231 and the attaching wall.

When the pocket door body 7 is hidden, the toggle block 8 of the pocket door body 7 drives the sliding member 6 to move towards the snap member 5, and thereby drives the movable rod 4 to move. The locking rod 41 of the sliding rod, when sliding towards the snap member 5, is first in contact with the sloping plate 5231 of the second limiting member 523, and then slides between the stopping rim 5221 and the second guiding block 5232 along the sloping plate 5231 until the pocket door body 7 is completely enters the wall groove. At this point, there is no second limiting member 523 on the right side of the locking rod 41, and the movable rod 4 rights itself, while the sliding block is rebounded by the rebound force of the elastic member 2, so that the locking rod 41 is allowed to slide into the snap position 5233 along a left wall of the first guiding bump 5222, thereby completing the locking state of the rebounder. When the user needs the pocket door to be extended from the wall and be opened, the pocket door body 7 is pressed towards the wall groove again. At this point, the first contact part 61 is snap-fitted with the toggle block 8 of the pocket door body 7, so that the first contact part 61 is configured to play an unlocking role. The first contact part 61, subjected to the force of the pocket door body 7, causes the movable rod 4 to move upwardly, to hit the first guiding bump 5222, and then to slide to a right side of the first guiding bump 5222, so that the locking rod 41 enters between the right side wall of the first guiding bump 5222 and the attaching wall. At this point, the user loosens the pressed pocket door body 7, the locking rod 41 is in a detached state, the sliding member 6 is rebounded back and reset by the rebound force of the elastic member 2 until the sliding member 6 is abutted against the resisting block 3. At this point, the protective sliding block 64, subjected to the abutting force of the resisting block 3, is abutted against the second snap edge 6213 of the snap rotating block 621 so that the second contact part 62 is popped out and reset, and the pocket door body 7 itself continues to slide outwardly under the influence of inertia, realizing the popping out effect of the pocket door body 7.

In this embodiment, the elastic member 2 is a reset spring. In other embodiments, the specific structure of the snap member 5 is not limited, and it is sufficient to be able to realize the locking state and the sliding out state.

The invention further relates to a pocket door, including a pocket door body 7, a pocket door rail and a rebounder having a damper. The rebounder housing 1 is assembled to an upper or lower edge of the pocket door body 7, and a toggle block 8, configured to be abutted against a first contact part 61 or a second contact part 62 protruding from the rebounder housing 1, is provided in the pocket door rail; or the rebounder housing 1 is assembled in the pocket door rail, and a toggle block 8, configured to be abutted against the first contact part 61 or the second contact part 62 protruding from the rebounder housing 1, is provided on a side wall of the pocket door body 7. When the pocket door body 7 is hidden and closed, the toggle block 8 of the pocket door body 7 drives the second contact part 62 to move synchronously, the sliding member 6 moves towards the snap member 5 along the sliding rail 11, and the locking rod 41 slides to the left side of the guiding bump 5222. At this point, the sliding member 6 can not continue to move forward so that the snap rotating block 621 of the second contact part 62 is automatically retracted, and at this point, the locking rod 41 is affected by the rebound force of the elastic member 2 to enter the snap position 5233 and to be lock. During the sliding of the toggle block 8 along the sliding space 13, the damper on the pocket door body 7 performs decelerating action on the door body, the action of hiding and closing door ends after the pocket door body 7 slides to a position where the pocket door body 7 is abutted against the first contact part 61, and at this point, the door is completely hidden into the wall. When the pocket door body 7 is opened and departed from the hidden state, the pocket door body 7 is pressed towards the wall. At this point, the first contact part 61 drives the sliding member 6 to slide towards the snap member 5, the locking rod 41 is detached from the snap position 5233 for unlocking, the sliding member 6 is reset and is abutted against the resisting block 3 by the rebound force of the elastic member 2, the pocket door body 7 is popped out by the rebound force of the reset spring, and the second contact part 62 is reset and is switched to the extended state in preparation for the next closing of the door.

In summary, the rebounder for a damping door and the pocket door provided in the present invention have the following technical effects: the rebounder housing 1 has a first contact part 61 and a second contact part 62 spaced apart, the sliding member 6 can be driven to realize a snap-fit effect with the clutch structure when the second contact part 62 is abutted against the toggle block 8, and the toggle block 8 can continue to decelerate and slide along the sliding space 13, which can allow the second contact part 6 with retraction function to retract, thereby driving the pocket door body 7 to be hidden into the wall. At this point the toggle block 8 is abutted against the first contact part 61, and then it can be realized that the rebounder and the damper can act individually, which avoids the mutual interference between those two. In addition, a length of the rebounder housing 1 is relatively great, so that the space between the first contact part 61 and the second contact part 62 is capable of providing the sliding space for the deceleration of the door body for the damper without increasing the depth of the door body groove.

The technical means disclosed in the solution of the present invention are not limited to those disclosed in the embodiments mentioned above but also include technical solutions consisting of any combination of the above technical features. It should be noted that for those skilled in the art, a plurality of improvements and modifications may be made without departing from the principles of the present invention. These improvements and modifications are also considered to be within the scope of protection of the present invention.

1. A rebounder for a damping door, applied to a pocket door body (7) having a damper, characterized in that the rebounder for the damping door comprises:
a rebounder housing (1), a sliding rail (11) being provided in the rebounder housing (1);
a sliding member (6), the sliding member (6) being slidably connected in the sliding rail (11);
an elastic member (2), the elastic member (2) being connected between the rebounder housing (1) and the sliding member (6);
a resisting block (3), the resisting block (3) being assembled in the sliding rail (11) for limiting an initial sliding position of the sliding member (6); and
a clutch structure, the clutch structure being connected between the rebounder housing (1) and the sliding member (6) for adjusting a relative position of the sliding member (6) in the sliding rail (11);
the sliding member (6) is provided with a first contact part (61) and a second contact part (62) having a retracting function, a spacing between the first contact part (61) and the second contact part (62) is a sliding space (13), and
the second contact part (62) is located on a side close to the resisting block (3), and the first contact part (61) is located on a side close to the clutch structure,
wherein, when the second contact part (62) is toggled to move the sliding member (6) to an end position, the sliding member (6) is snap-fitted with the clutch structure, the second contact part (62) is switched to a retracted state, and the sliding space (13) is open.

2. The rebounder for the damping door according to claim 1, characterized in that a first assembly member (14) is provided at an end of the rebounder housing (1), a second assembly member (15) is provided at an opposite end of the rebounder housing (1), and the first assembly member (14) and the second assembly member (15) are configured to assemble the rebounder housing (1) in a pocket door rail or on the pocket door body (7).

3. The rebounder for the damping door according to claim 1, characterized in that the second contact part (62) comprises:
a snap rotating block (621), the snap rotating block (621) being rotatably connected to the sliding member (6); and
a torsion spring (622), the torsion spring (622) rotating the snap rotating block (621) so that the snap rotating block (621) protrudes from a side of the sliding member (6) for being abutted against the pocket door body (7) or the pocket door rail.

4. The rebounder for the damping door according to claim 2, characterized in that the second contact part (62) comprises:
a snap rotating block (621), the snap rotating block (621) being rotatably connected to the sliding member (6); and
a torsion spring (622), the torsion spring (622) rotating the snap rotating block (621) so that the snap rotating block (621) protrudes from a side of the sliding member (6) for being abutted against the pocket door body (7) or the pocket door rail.

5. The rebounder for the damping door according to claim 3, characterized in that the snap rotating block (621) comprises:
a rotating shaft part (6211), the rotating shaft part (6211) being rotatably connected to the sliding member (6);
a first snap edge (6212), the first snap edge (6212) being configured to be abutted against the pocket door body (7) or the pocket door rail; and
a second snap edge (6213), wherein the second snap edge (6213) is abutted against the torsion spring (622) to push the second snap edge (6213) to rotate towards the first snap edge (6212), such that the first snap edge (6212) is rotated to outside of the sliding member (6) with the rotating shaft part (6211) as a center.

6. The rebounder for the damping door according to claim 4, characterized in that the snap rotating block (621) comprises:
a rotating shaft part (6211), the rotating shaft part (6211) being rotatably connected to the sliding member (6);
a first snap edge (6212), the first snap edge (6212) being configured to be abutted against the pocket door body (7) or the pocket door rail; and
a second snap edge (6213), wherein the second snap edge (6213) is abutted against the torsion spring (622) to push the second snap edge (6213) to rotate towards the first snap edge (6212), such that the first snap edge (6212) is rotated to outside of the sliding member (6) with the rotating shaft part (6211) as a center.

7. The rebounder for the damping door according to claim 5, characterized in that the sliding member (6) is slidably provided with a protective sliding block (64), a sliding direction of the protective sliding block (64) is as same as a sliding direction of the sliding member (6), and the second snap edge (6213) is abutted against the protective sliding block (64) when the snap rotating block (621) is rotated to protrude from the sliding member (6).

8. The rebounder for the damping door according to claim 6, characterized in that the sliding member (6) is slidably provided with a protective sliding block (64), a sliding direction of the protective sliding block (64) is as same as a sliding direction of the sliding member (6), and the second snap edge (6213) is abutted against the protective sliding block (64) when the snap rotating block (621) is rotated to protrude from the sliding member (6).

9. The rebounder for the damping door according to claim 7, characterized in that a guiding surface (641) is provided on a side of the protective sliding block (64) abutted against the snap rotating block (621), and the guiding surface (641) is configured to allow the snap rotating block (621) to push the protective sliding block (64) to slide towards the resisting block (3) along the guiding surface (641) when the snap rotating block (621) is rotated into the sliding member (6).

10. The rebounder for the damping door according to claim 8, characterized in that a guiding surface (641) is provided on a side of the protective sliding block (64) abutted against the snap rotating block (621), and the guiding surface (641) is configured to allow the snap rotating block (621) to push the protective sliding block (64) to slide towards the resisting block (3) along the guiding surface (641) when the snap rotating block (621) is rotated into the sliding member (6).

11. The rebounder for the damping door according to claim 1, characterized in that the clutch structure comprises:
a movable rod (4), an end of the movable rod (4) being connected to the sliding member (6) and another end thereof being bent to form a locking rod (41); and
a snap member (5), the snap member (5) being assembled in the sliding rail (11) at an opposite end of the sliding rail (11), and having a snap position (5233),
wherein the locking rod (41) is allowed to be locked with or detached from the snap position (5233) when the sliding member (6) drives the movable rod (4) to move towards the snap member (5).

12. The rebounder for the damping door according to claim 7, characterized in that the snap member (5) comprises:
a snap seat body (51), the snap seat body (51) having an accommodating cavity (511); and
a snap limiting member (52), the snap limiting member (52) being assembled in the accommodating cavity (511) and comprising:
a snap base plate (521), the snap base plate (521) being snap-fitted into the accommodating cavity (511) of the snap seat body (51);
a first limiting member (522), the first limiting member (522) being provided on the snap base plate (521) to limit a movement direction of the locking rod (41) when sliding; and
a second limiting member (523), wherein the second limiting member (523) is provided on the snap base plate (521) and is provided opposite to the first limiting member (522) for cooperating with the first limiting member (522) to allow the locking rod (41) to slide into the snap position (5233) or slide out of the snap position (5233).

13. The rebounder for the damping door according to claim 8, characterized in that the snap seat body (51) is provided with a lateral mounting hole (512), the lateral mounting hole (512) is assembled with a lateral mounting plate (53), the lateral mounting hole (512) is in communication with the accommodating cavity (511) for mounting the snap limiting member (52) from the lateral mounting hole (512).

14. A pocket door, comprising a pocket door body (7), a pocket door rail and the rebounder for the damping door as claimed in claim 1, characterized in that the rebounder housing (1) is assembled to an upper or lower edge of the pocket door body (7), and a toggle block (8), configured to be abutted against a first contact part (61) or a second contact part (62) protruding from the rebounder housing (1), is provided in the pocket door rail; or, the rebounder housing (1) is assembled in the pocket door rail, and a toggle block (8), configured to be abutted against the first contact part (61) or the second contact part (62) protruding from the rebounder housing (1), is provided on a side wall of the pocket door body (7), so as to enable the pocket door body (7) to be completely hidden into a wall without being affected by the damper.

15. A pocket door, comprising a pocket door body (7), a pocket door rail and the rebounder for the damping door as claimed in claim 2, characterized in that the rebounder housing (1) is assembled to an upper or lower edge of the pocket door body (7), and a toggle block (8), configured to be abutted against a first contact part (61) or a second contact part (62) protruding from the rebounder housing (1), is provided in the pocket door rail; or, the rebounder housing (1) is assembled in the pocket door rail, and a toggle block (8), configured to be abutted against the first contact part (61) or the second contact part (62) protruding from the rebounder housing (1), is provided on a side wall of the pocket door body (7), so as to enable the pocket door body (7) to be completely hidden into a wall without being affected by the damper.

16. A pocket door, comprising a pocket door body (7), a pocket door rail and the rebounder for the damping door as claimed in claim 3, characterized in that the rebounder housing (1) is assembled to an upper or lower edge of the pocket door body (7), and a toggle block (8), configured to be abutted against a first contact part (61) or a second contact part (62) protruding from the rebounder housing (1), is provided in the pocket door rail; or, the rebounder housing (1) is assembled in the pocket door rail, and a toggle block (8), configured to be abutted against the first contact part (61) or the second contact part (62) protruding from the rebounder housing (1), is provided on a side wall of the pocket door body (7), so as to enable the pocket door body (7) to be completely hidden into a wall without being affected by the damper.

17. A pocket door, comprising a pocket door body (7), a pocket door rail and the rebounder for the damping door as claimed in claim 4, characterized in that the rebounder housing (1) is assembled to an upper or lower edge of the pocket door body (7), and a toggle block (8), configured to be abutted against a first contact part (61) or a second contact part (62) protruding from the rebounder housing (1), is provided in the pocket door rail; or, the rebounder housing (1) is assembled in the pocket door rail, and a toggle block (8), configured to be abutted against the first contact part (61) or the second contact part (62) protruding from the rebounder housing (1), is provided on a side wall of the pocket door body (7), so as to enable the pocket door body (7) to be completely hidden into a wall without being affected by the damper.

18. A pocket door, comprising a pocket door body (7), a pocket door rail and the rebounder for the damping door as claimed in claim 5, characterized in that the rebounder housing (1) is assembled to an upper or lower edge of the pocket door body (7), and a toggle block (8), configured to be abutted against a first contact part (61) or a second contact part (62) protruding from the rebounder housing (1), is provided in the pocket door rail; or, the rebounder housing (1) is assembled in the pocket door rail, and a toggle block (8), configured to be abutted against the first contact part (61) or the second contact part (62) protruding from the rebounder housing (1), is provided on a side wall of the pocket door body (7), so as to enable the pocket door body (7) to be completely hidden into a wall without being affected by the damper.

19. A pocket door, comprising a pocket door body (7), a pocket door rail and the rebounder for the damping door as claimed in claim 6, characterized in that the rebounder housing (1) is assembled to an upper or lower edge of the pocket door body (7), and a toggle block (8), configured to be abutted against a first contact part (61) or a second contact part (62) protruding from the rebounder housing (1), is provided in the pocket door rail; or, the rebounder housing (1) is assembled in the pocket door rail, and a toggle block (8), configured to be abutted against the first contact part (61) or the second contact part (62) protruding from the rebounder housing (1), is provided on a side wall of the pocket door body (7), so as to enable the pocket door body (7) to be completely hidden into a wall without being affected by the damper.

20. A pocket door, comprising a pocket door body (7), a pocket door rail and the rebounder for the damping door as claimed in claim 7, characterized in that the rebounder housing (1) is assembled to an upper or lower edge of the pocket door body (7), and a toggle block (8), configured to be abutted against a first contact part (61) or a second contact part (62) protruding from the rebounder housing (1), is provided in the pocket door rail; or, the rebounder housing (1) is assembled in the pocket door rail, and a toggle block (8), configured to be abutted against the first contact part (61) or the second contact part (62) protruding from the rebounder housing (1), is provided on a side wall of the pocket door body (7), so as to enable the pocket door body (7) to be completely hidden into a wall without being affected by the damper.
